(19) United States
(12) Patent Application Publication
(10) Pub. No.: US 2023/0162285 A1
(43) Pub. Date: May 25, 2023

(54) METHOD AND SYSTEM FOR PROVIDING INVESTMENT INFORMATION OF COMPANY THROUGH PATENT QUALITY EVALUATION

(71) Applicant: SEOUL NATIONAL UNIVERSITY R&DB FOUNDATION, Seoul (KR)

(72) Inventors: Bong-Chan KHO, Seoul (KR); Woosung JUNG, Seoul (KR)

(73) Assignee: SEOUL NATIONAL UNIVERSITY R&DB FOUNDATION, Seoul (KR)

(21) Appl. No.: 17/974,756

(22) Filed: Oct. 27, 2022

(30) Foreign Application Priority Data
Nov. 24, 2021 (KR) 10-2021-0162886
Dec. 1, 2021 (KR) 10-2021-0169729
Apr. 18, 2022 (KR) 10-2022-0047393

(51) Int. Cl. G06Q 40/06; G06Q 30/02; G06Q 50/18

(52) U.S. Cl. CPC G06Q 40/06; G06Q 30/0201; G06Q 50/184

(57) ABSTRACT

An embodiment of the present disclosure provides a method for providing investment information of a company through patent quality evaluation performed by a server. The present disclosure relates to a method and a system for providing investment information of a company through patent quality evaluation, and more specifically, to a method and a system for providing investment information of a company by calculating a patent quality index of the company based on various patent information, and calculating a ratio of market capitalization to patent quality based on the market capitalization and patent quality index of the company.

### CROSS-REFERENCE TO RELATED APPLICATIONS

The present application claims priority under 35 U.S.C 119(a) to Korean Patent Application No. 10-2021-0162886, filed on Nov. 24, 2021, No. 10-2021-0169729, filed on Dec. 1, 2021, and No. 10-2022-0047393, filed on Apr. 18, 2022, which is incorporated herein by reference in its entirety.

### BACKGROUND

### 1. Technical Field

The present disclosure relates to a method and a system for providing investment information of a company through patent quality evaluation, and more specifically, to a method and a system for providing investment information of a company by calculating a patent quality index of the company based on various patent information, and calculating a ratio of market capitalization to patent quality based on the market capitalization and patent quality index of the company.

### 2. Related Art

In the past, stock price prediction and analysis of a company were conducted with an investment index calculated based on the tangible assets of the company. In recent years, as many economic activities change from a production base driven by workers to a service base operated by knowledge workers, important factors in production activities of the company have also changed, thereby increasing the importance of intangible intellectual assets such as patents.

In this regard, a technology has been developed to analyze the relationship between a company's value or stock price and patents using several patent indicators such as patent citations. However, since the prior art fragmentarily uses the patent-related indicators, it does not sufficiently reflect various information of patents that change according to the development of science and technology, and the passage of time.

Therefore, in order to fully utilize the patent information which has been fragmentarily handled in the prior art, it is necessary to develop technologies that may generate information which may help comprehensively calculate and optimize various patent quality indicators, timely and accurately evaluate the quality of patents owned by the company, and predict the stock price of the company using the evaluation results.

### SUMMARY

The present disclosure is provided to solve the above-mentioned problems, an object thereof is to provide a method and a system for providing investment information of a company through a patent quality evaluation in which a quality index of patents owned by the company is calculated by using various patent information, and a ratio of market capitalization to patent quality is calculated based on the market capitalization and patent quality index of the company.

The technical problems to be solved by the present disclosure are not limited to the above-mentioned technical problems, and other technical problems of the present disclosure may be derived from the following description.

As technical means for solving the above-mentioned technical problems, according to one aspect of the present disclosure, there is provided a method for providing investment information of a company through a patent quality evaluation performed by a server. The method includes a step of calculating a numerical value of each of a plurality of patent quality indicators for each valid patent, and performing the first principal component analysis on the calculated numerical values to select a plurality of main quality indicators from among the patent quality indicators; a step of calculating numerical values of the main quality indicators for the analysis target patents whose rights have not expired in a specific period among the valid patents, calculating weights of the main quality indicators for computing a patent score based on principal component coefficients obtained by conducting the second principal component analysis on the calculated numerical values, and calculating the patent scores of the analysis target patents based on the weights and numerical values of the main quality indicators; a step of calculating weights for computing the patent quality index based on the market size of the technology sector to which the analysis target patent belongs, and calculating the patent quality index of the company corresponding to the right holder of the analysis target patents by weighted-summing patent scores with the weights; and a step of calculating a price-to-patent quality index ratio of the company by using the market capitalization and patent quality index of the company.

In addition, as technical means for solving the above-mentioned technical problems, according to another aspect of the present disclosure, there is provided a system for providing investment information of a company through patent quality evaluation with communication connection to a terminal. The system includes a communication module that performs transmission and reception of information with the terminal; a memory that stores a company investment information providing program; and a processor that executes the program stored in the memory. The processor executes the company investment information providing program to calculate a numerical value of each of a plurality of patent quality indicators for each registered valid patent, and perform the first principal component analysis on the calculated numerical values to select a plurality of main quality indicators from among the patent quality indicators, to calculate numerical values of the main quality indicators for the analysis target patents whose right have not expired in a specific period among the valid patents, calculate weights of the main quality indicators for computing a patent score based on principal component coefficients obtained by conducting the second principal component analysis on the calculated numerical values, and calculate the patent scores of the analysis target patents based on the weights and numerical values of the main quality indicators, to calculate weights for computing the patent quality index based on a market size of the technical field to which the analysis target patent belongs, and weighted-sum the patent scores with the weights to calculate the patent quality index of the company corresponding to the right holder of the analysis target patents, and to calculate a price-to-patent quality index ratio of the company by using the market capitalization and patent quality index of the company.

According to the means for solving the above-mentioned technical problems of the present disclosure, the patent quality indicators were fragmentarily handled in the prior art, whereas the present disclosure classifies the patent quality indicators into a technological significance indicator, an inventor expertise indicator, a marketability indicator, a novelty indicator, a patent scope indicator, and a patent right indicator, and optimizes them comprehensively. Therefore, it is possible to generate the company investment information based on main patent quality indicators suitable for representing changes in patent quality.

In addition, according to the present disclosure, it is presented a methodology capable of applying optimal weights obtained from the principal component analysis to main patent quality indicators to synthesize a patent score and continuously tracking the patent quality that changes over time.

In addition, according to the present disclosure, a methodology is presented in which the patent quality index that may evaluate a patent portfolio of the company is calculated, and predictive power for stock returns through the price-to-patent quality index ratio (PPR), which is a relative evaluation index that expresses the stock price as a ratio to patent quality index, is excellent.

In addition, according to the present disclosure, it is possible to provide company investment information that non-experts may easily utilize for stock price prediction by providing users with the company investment information such as the corresponding patent quality index and the price-to-patent quality index ratio.

### BRIEF DESCRIPTION OF THE DRAWINGS

Various embodiments of the present disclosure will become more apparent in view of the attached drawings and accompanying detailed description, in which:

FIG. 1 is a diagram illustrating a system for providing investment information of a company through patent quality evaluation connected to a terminal in communication according to an embodiment of the present disclosure;

FIG. 2 is a block diagram illustrating a configuration of the system for providing investment information of a company through patent quality evaluation shown in FIG. 1;

FIG. 3 is a flowchart illustrating a sequence of a method for providing investment information of a company through patent quality evaluation according to another embodiment of the present disclosure; and

FIGS. 4 to 6 are flowcharts illustrating detailed steps included in the steps of the system for providing investment information of a company through patent quality evaluation shown in FIG. 3.

### DETAILED DESCRIPTION OF THE EMBODIMENTS

Hereinafter, the present disclosure will be described in detail with reference to the accompanying drawings. However, the present disclosure may be implemented in various different forms, and is not limited to the embodiments described herein. In addition, the accompanying drawings are only for easy understanding of the embodiments disclosed in the present specification, and the technical ideas disclosed in the present specification are not limited by the accompanying drawings. All terms including technical terms and scientific terms used herein have to be interpreted as meanings commonly understood by those of ordinary skill in the art to which the present disclosure belongs. Terms defined in the dictionary have to be interpreted as having additional meanings consistent with the related technical literature and the presently disclosed content, and are not interpreted in a very ideal or limiting sense unless otherwise defined.

In order to clearly explain the present disclosure in the drawings, parts irrelevant to the description are omitted, and the size, form, and shape of each component shown in the drawings may be variously modified. The same/similar reference numerals are attached to the same/similar parts throughout the specification.

The suffixes “module” and “portion” for components used in the following description are given or mixed in consideration of only the ease of writing the specification, and do not have distinct meanings or roles by themselves. In addition, in describing the embodiments disclosed in the present specification, when it is determined that detailed descriptions of related known technologies may obscure the gist of the embodiments disclosed in this specification, detailed descriptions thereof are omitted.

Throughout the specification, when a part is “connected (coupled, contacted, or combined)” with another part, this includes not only a case of being “directly connected (coupled, contacted, or combined)” but also a case of being “indirectly connected (coupled, contacted, or combined)” with another element interposed therebetween. Also, when a part “includes (has or provides)” a configuration element, it means that other configuration elements may be further included (had or provided), rather than excluding other configuration elements, unless otherwise stated.

Terms indicating an ordinal number such as first and second used herein are used only for the purpose of distinguishing one component from another, and do not limit the order or relationship of the components. For example, a first component of the present disclosure may be referred to as a second component, and similarly, a second component may also be referred to as a first component. Forms of the singular expression used herein has to be construed to include forms of the plural expression as well, unless the meaning is clearly opposite.

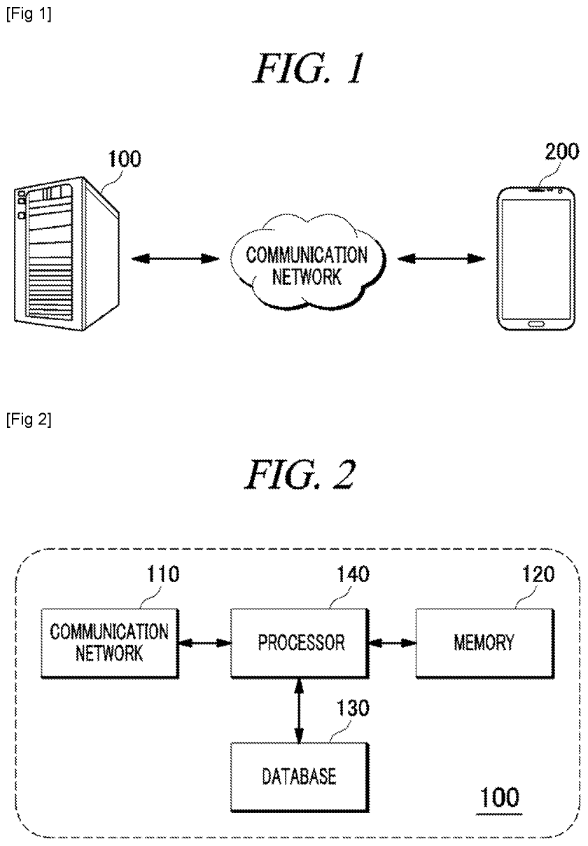

FIG. 1 is a diagram illustrating a system for providing investment information of a company through patent quality evaluation (hereinafter, referred to as a company investment information providing system 100) connected to a terminal 200 in communication according to an embodiment of the present disclosure.

Referring to FIG. 1, the company investment information providing system 100 and the terminal 200 may be interconnected through a wired or wireless communication network. The company investment information providing system 100 may be formed of a cloud computing server such as Software as a Service (SaaS), Platform as a Service (PaaS), or Infrastructure as a Service (IaaS). The terminal 200 may refer to, for example, all types of handheld-based wireless communication devices such as a notebook, a desktop, and a laptop equipped with a web browser, and a wireless communication device, a smartphone, and a touchpad with guaranteed portability and mobility. A communication network may be implemented with a wired network such as a local area network (LAN), a wide area network (WAN), or a value added network (VAN), or all types of wireless networks such as a mobile radio communication network or a satellite communication network.

The terminal 200 may be a user's terminal. The terminal 200 may transmit a specific period and specific company information to the company investment information providing system 100, and output and display the company investment information from the company investment information providing system 100 on a display.

More specifically, the terminal 200 may include a communication module, a memory, an input/output module, and a processor.

The communication module performs information transmission and reception with the company investment information providing system 100. The communication module may include a device including hardware and software necessary for transmitting and receiving signals such as control signals or data signals through wired/wireless connection with other network devices.

The memory stores an investment analysis program. A name of the investment analysis program is set for convenience of explanation, and the name itself does not limit a function of the program. The memory may store at least one of information and data input to a communication module, information and data necessary for a function performed by a processor, and data generated according to the execution of the processor. The memory has to be interpreted as a generic term for a non-volatile storage device that continuously maintains stored information even when power is not supplied, and a volatile storage device that requires power to maintain the stored information. In addition, the memory may perform a function of temporarily or permanently storing data processed by the processor. The memory may include magnetic storage media or flash storage media in addition to the volatile storage device that requires power to maintain the stored information, but the scope of the present disclosure is not limited thereto.

The input/output module may receive information, data, or the like transmitted from the outside to the terminal 200, or may output information, data, or the like possessed by the terminal 200 to the outside. For example, the input/output module may include a display, a touchpad, a speaker, a microphone, and the like.

The processor may include various types of devices for controlling and processing data. The processor may refer to a data processing device embedded in hardware having a physically structured circuit to perform a function expressed as code or instructions included in a program. In one example, the processor may be implemented in a form such as a microprocessor, a central processing unit (CPU), a processor core, a multiprocessor, an application-specific integrated circuit (ASIC), or a field programmable gate array (FPGA), but the scope of the present disclosure is not limited thereto. The processor is configured to execute an investment analysis program for each company stored in the memory to perform the following functions and procedures.

The processor generates a search information input interface in the input/output module, inputs the specific period and specific company information to be searched in the interface, and transmits the input to the company investment information providing system 100.

The processor may receive company investment information corresponding to the specific period and specific company information from the company investment information providing system 100.

FIG. 2 is a block diagram illustrating a configuration of the company investment information providing system 100 through patent quality evaluation.

Referring to FIGS. 1 and 2 together, the company investment information providing system 100 includes a communication module 110, a memory 120, and a processor 140, and may further include a database 130.

The communication module 110 may transmit and receive information to and from the terminal 200. The communication module 110 may include a device including hardware and software necessary for transmitting and receiving signals such as control signals or data signals through wired/wireless connection with other network devices.

The memory 120 stores the company investment information providing program. The name of the company investment information providing program is set for convenience of explanation, and the name itself does not limit the function of the program. The memory 120 may be configured to store at least one of data input to the communication module 110, data necessary for a function performed by the processor 140, and data generated according to the execution of the processor 140. The memory 120 has to be interpreted as a generic term for a non-volatile storage device that continuously maintains stored information even when power is not supplied, and a volatile storage device that requires power to maintain the stored information. The memory 120 may perform a function of temporarily or permanently storing data processed by the processor 140. The memory 120 may include magnetic storage media or flash storage media in addition to the volatile storage device that requires power to maintain the stored information, but the scope of the present disclosure is not limited thereto.

The database 130 may be a place in which data necessary for generating the company investment information is stored. The database 130 may be built in a part of the memory 120 or implemented as separate hardware.

The processor 140 is configured to execute the company investment information providing program stored in the memory 120. The processor 140 may include various types of devices for controlling and processing data. The processor 140 may refer to a data processing device embedded in hardware having a physically structured circuit to perform a function expressed as a code or an instruction included in a program. In one example, the processor 140 may be implemented in a form such as a microprocessor, a central processing unit (CPU), a processor core, a multiprocessor, an application-specific integrated circuit (ASIC), or a field programmable gate array (FPGA), but the scope of the present disclosure is not limited thereto.

The processor 140 is configured to execute the company investment information providing program to perform the following functions and procedures.

The processor 140 calculates a numerical value of each of a plurality of patent quality indicators for each registered valid patent. More specifically, the processor 140 may extract a patent evaluation factor for calculating the patent quality indicator from valid patents, and calculate a numerical value of each patent quality indicators based on the patent evaluation factor. The valid patents may be information received and stored from a patent office and a patent search database. The patent quality indicator includes a technological significance indicator, an inventor expertise indicator, a marketability indicator, a novelty indicator, a patent scope indicator, and a patent right indicator. The processor 140 selects a plurality of main quality indicators from among the patent quality indicators by performing the first principal component analysis on the calculated numerical value of each of the plurality of patent quality indicators. More specifically, the processor 140 performs the first principal component analysis on the numerical value of each of the plurality of patent quality indicators to calculate principal component coefficients (loadings) of the principal components generated by a linear combination of the patent quality indicators. The processor 140 selects the patent quality indicator having a principal component coefficient equal to or greater than a preset value from among the principal component coefficients as the main quality indicator.

The processor 140 calculates numerical values of the main quality indicators on the analysis target patents whose rights have not expired during a specific period among the valid patents. The processor 140 calculates weights for computing a patent score based on the principal component coefficients obtained by performing the second principal component analysis on the corresponding numerical values. The processor 140 calculates the patent score of the analysis target patent based on the weights for computing the patent score and the numerical values of the main quality indicators for the analysis target patents. More specifically, the processor 140 calculates the principal component coefficients (loadings), a variance proportion and a cumulative variance proportion of each principal component generated by a linear combination with the main quality indicators through the second principal component analysis on the main quality indicators for the analysis target patents.

The processor 140 selects principal components of which the cumulative variance proportion explained is equal to or less than a preset value as the main principal components, and calculates the variance contribution of each main principal component based on the variance proportions and cumulative variance proportions of the main principal components. The preset value may be 90% or less. The processor 140 calculates weights for computing a patent score based on the coefficients and calculated variance contribution of the main principal components. The processor 140 calculates the patent score of the analysis target patent based on the corresponding weights and numerical values of main quality indicators on the analysis target patent.

The processor 140 weighted-sums the patent scores for each patent holding company based on the market size of the technology sector to which the corresponding patent belongs to calculate the company's patent quality index (hereinafter, referred to as “patent index”). In order to calculate the market size for each technology sector, the processor 140 counts the number of patents for each technology sector to which the analysis target patent belongs, the number of patents for each company, and sales for each company having the analysis target patents. The processor 140 calculates the average sales per patent for each technology sector based on the number of patents and sales for each company. The processor 140 calculates the market size for each technology sector based on the average sales per patent and number of patents for each technology sector. The processor 140 calculates a weight for computing the patent index, which is the ratio of the market size for a specific technology sector to the total market size for the entire technology sector, and calculates the patent index for each company based on the patent scores and the weights. The processor 140 may collect information such as the number of patents and the patent index for each company based on information on the applicant and the right holder included in the patent information.

The processor 140 derives the price-to-patent index ratio for each company by using the patent index and market capitalization of each company.

The processor 140 may receive the specific period and specific company information from the terminal 200, and generate company investment information including at least one of the valid patent information corresponding to the specific period and specific company information, the stored company information, the numerical values of the main quality indicators, the patent index for each company, and the price-to-patent index ratio for each company, and provide the corresponding information to the terminal 200.

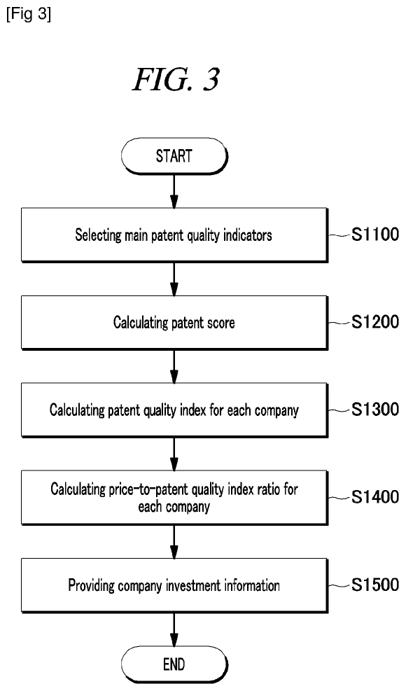

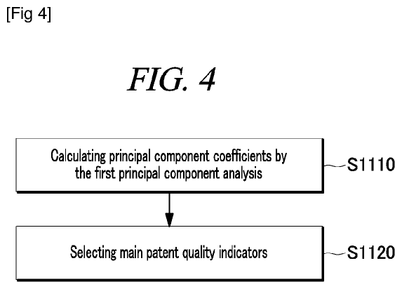

FIG. 3 is an operation flowchart for explaining a method for providing investment information of a company through patent quality evaluation according to another embodiment of the present disclosure, and FIGS. 4 to 6 are flowcharts illustrating detailed steps included in some steps of the method for providing investment information of a company through patent quality evaluation. Hereinafter, the method for providing investment information of a company through patent quality evaluation will be described with reference to FIGS. 3 to 6. Each step of the method for providing investment information of a company through patent quality evaluation to be described below may be performed by the company investment information providing system 100 through patent quality evaluation described above with reference to FIGS. 1 to 2. Accordingly, the contents of the embodiment of the present disclosure described above-mentioned with reference to FIGS. 1 and 2 may be equally applied to the embodiment to be described below, and hereinafter, the contents overlapping with the above descriptions below will be omitted. The steps described below do not necessarily have to be performed in order, the order of the steps may be set in various ways, and the steps may be performed almost simultaneously.

Referring to FIG. 3, the method for providing investment information of a company through patent quality evaluation includes a step of selecting main patent quality indicators S1100, a step of calculating patent score for each company S1200, a step of calculating patent quality index for each company S1300, a step of calculating price-to-patent quality index ratio for each company S1400, and a step of providing company investment information S1500.

The step of selecting main patent quality indicators S1100 is a step in which a numerical value of each of a plurality of patent quality indicators for registered valid patents is calculated, and the first principal component analysis is performed on the corresponding numerical value to select a plurality of main quality indicators among from the patent quality indicators. More specifically, in the step of selecting main patent quality indicators S1100, a patent evaluation factor for calculating a patent quality indicator may be extracted from the valid patents, and the patent quality indicator may be calculated based on the corresponding patent evaluation factor. The valid patents may be information received and stored from a patent office and a patent search database. The patent quality indicator includes a technological significance indicator, an inventor expertise indicator, a marketability indicator, a novelty indicator, a patent scope indicator, and a patent right indicator. The technological significance indicator includes indicators such as forward-citations, adjusted forward-citations, forward-citations by foreign assignees, self-forward citations, and an average forward-citation interval. The inventor expertise indicator includes indicators such as the number of applications, the number of registrations, a registration ratio, the number of adjusted forward-citations, the number of patent families, the number of continuing patents, an average pending period, the total number of claims, and the total remained life of patents. All values of the inventor expertise indicators are averaged across inventors assigned to the patent. The marketability indicator includes indicators such as the patent family size based on the application, the patent family size based on the distinct authorities, and intended worldwide protection. The novelty indicator includes indicators such as backward-citations and self-backward citations. The patent scope indicator includes indicators such as forward-citations by examiners, self-forward citations by examiners, forward-citations by examiners based on five or more domestic family patents, forward-citations by examiners based on three or more foreign family patents, forward-citations by examiners based on the top 10% assignees in the technology sector concerned, citations by patents registered by applicants who are in the top 10% of registered patents in the past two years in the same technical field among citations, forward-citations by examiners based on the patents currently owned by companies with more than 500 patent applications, backward-citations by examiners, and self-backward citations by examiners. The patent right indicator includes indicators such as the number of continuing patents, the number of claims, the number of added net claims, the number of multiple applicants, the size of inventors, the number of patent classifications, and the patent maturity. The detailed descriptions of the patent quality indicators may be shown through Table 1 below.

TABLE 1

| | | | |
|---|---|---|---|
| | Patent | | |
| | quality | | |
| No. | indicator | Effects | Description |

Technological significance

| | | | |
|---|---|---|---|
| *1 | Forward- | + | This indicator is the total number of forward |
| | citation | | citations that a given patent receives over time. It |
| | | | reflects the technological importance of the patent |
| | | | for the development of subsequent technologies |
| | | | and mirrors the economic value of the |
| | | | technological innovation. (Trajtenberg, 1990; Hall |
| | | | et al., 2005; Harhoff et al., 2003) |
| *2 | Adjusted | + | This indicator is the forward-citation count of a |
| | forward- | | patent scaled by the average number of forward |
| | citation | | citations received by patents in the same |
| | | | technological sector, in the same grant year, and |
| | | | in the same citing year of the patent. This |
| | | | adjustment follows Gu (2005) to help control for |
| | | | citation propensity attributed to differences in |
| | | | technology sector, grant year, and citing year. |
| 3 | Forward- | + | This indicator is the number of total forward- |
| | citations by | | citations made by foreign assignees, indicating |
| | foreign | | strong influences beyond the local area. |
| | assignees | | |
| 4 | Self-forward | + | This indicator is the total number of forward |
| | citations | | citations made by patents filed by the same |
| | | | applicant. Hall et al. (2005) suggest that self- |
| | | | forward citations are generally more valuable than |
| | | | citations from external patents. |
| 5 | Average | + | This indicator is the average of months elapsed |
| | forward- | | between the grant date and the cited date. The |
| | citation | | longer duration of citations, the longer |
| | interval | | technological life of a patent. |
| | (months) | | |

Inventor expertise

| | | | |
|---|---|---|---|
| *6 | Number of | + | This indicator is the total number of applications |
| | applications | | that an inventor has filed. A large number of |
| | (inventor | | applications indicates that inventors keep doing |
| | average) | | patenting activities intensively for a long time. |
| *7 | Number of | + | This indicator is the total number of applications |
| | registrations | | that an inventor has registered. A large number of |
| | (inventor | | registered applications indicates inventors' |
| | average) | | achievement in innovation. |
| 8 | Registration | + | This indicator is the number of registrations |
| | ratio (inventor | | divided by the number of applications, measuring |
| | average) | | the efficiency of patenting activities of inventors. |
| *9 | Number of | + | This indicator is the total number of adjusted |
| | adjusted | | forward citations of patents that an inventor has |
| | forward- | | registered, indicating that the inventor has |
| | citations | | participated in the influential invention. |
| | (inventor | | |
| | average) | | |
| *10 | Number of | + | This indicator is the total number of patents |
| | patents with | | assigned to an inventor that are in the patent |
| | family | | family. The patent family's aggregate number of |
| | (inventor | | patents indicates that the inventor has |
| | average) | | participated in the critical invention to the |
| | | | assignee. |
| 11 | Number of | + | This indicator is the total number of patents |
| | patents with | | assigned to an inventor that are in the part of |
| | continuing | | continuing patents. The number of continuing |
| | patents | | patents that an inventor has registered indicates |
| | (inventor | | that the inventor has done innovation activities in |
| | average) | | the focused technological sector and those |
| | | | innovations tend to be at a higher technological |
| | | | level. |
| 12 | Average | − | This index is the average of the months elapsed |
| | pending | | between the filing date and the registration date |
| | period | | of the patents filed by the inventor, and the length |
| | (inventor | | of the registration period has a negative |
| | average, | | correlation with the patent value. (Harhoff and |
| | months) | | Wagner, 2009; Regibeau and Rockett, 2010) |
| *13 | Total claims | + | This indicator is the total number of claims of |
| | of patents | | patents that an inventor has filed. Claims |
| | (inventor | | determine the boundaries of the exclusive rights |
| | average) | | of a patent owner. Moreover, as the patent fee is |
| | | | proportional to the number of claims, a large |
| | | | number of claims imply higher fees and, therefore, |
| | | | reflect its expected market value (Tong and |
| | | | Frame, 1994; Lanjouw and Schankerman, 2001, |
| | | | 2004) |
| *14 | Total | + | This indicator is the total months left of patents |
| | remained life | | that an inventor has filed. This describes the |
| | of patents | | remaining time for a patent's protection right and, |
| | (inventor | | thus, represents that an inventor has been |
| | average, | | involved intensively in patenting activities recently |
| | months) | | for a long time. |

Marketability

| | | | |
|---|---|---|---|
| *15 | Patent family | + | This index is the number of patents filed in |
| | size | | different countries but with the same priority, |
| | (Applications) | | which has proven valuable for large international |
| | | | patent families. (Harhoff et al., 2003). |
| *16 | Patent family | + | This index is the number of patent bodies in which |
| | size (Distinct | | patents in a patent family have been filed, which |
| | authorities) | | are valuable in more jurisdictions where patent |
| | | | protection is required. (Lanjouw et al., 1998). |
| *17 | Intended | + | This indicator is the number of PCT (patent |
| | worldwide | | cooperation treaty) filings in the patent family. If |
| | protection | | more than one PCT filing exists in the family, |
| | | | worldwide protection is planned and, thus, the |
| | | | market coverage of the invention is global. |

Novelty

| | | | |
|---|---|---|---|
| *18 | Backward- | +/− | This indicator is the number of prior patents cited |
| | citations | | in the application of a patent, which help assess |
| | | | the degree of novelty of an invention and |
| | | | investigate knowledge transfers in terms of |
| | | | citations network. However, its impact on patent |
| | | | value is not conclusive. Harhoff et al. (2003) show |
| | | | that backward citations have been found to be |
| | | | positively related to the value of a patent, while |
| | | | Lanjouw and Schankerman (2001) suggests that |
| | | | large numbers of backward citations may signal |
| | | | the patent to be more incremental than more |
| | | | innovative. |
| 19 | Self- | − | This indicator is the total number of citations made |
| | backward | | to inventions belonging to the same agent. The |
| | citations | | patent with high self-backward citation counts |
| | | | tends to be incremental rather than innovative. |

Patent scope—Citations added by examiner as they work as a patent
scope that blocks subsequent inventions and has a positive impact on
renewal probability

| | | | |
|---|---|---|---|
| *20 | Forward- | + | This indicator is the total number of forward- |
| | citations by | | citations added to the citing patent by examiners |
| | examiners | | during the technical examination. This can be |
| | | | seen to be more critical than other forward |
| | | | citations as this confirms the validity of the forward |
| | | | citation. |
| 21 | Self-forward | + | This indicator is a self-forward citation count |
| | citations by | | added by examiners. This is also more crucial |
| | examiners | | than other self-forward citations because this |
| | | | confirms the validity of the self-forward citation. |
| *22 | Forward- | + | This is the total number of forward-citations made |
| | citations by | | by domestic patents with large domestic patent |
| | examiners | | families, added by examiners during the technical |
| | based on five | | examination. This represents that a patent is cited |
| | or more | | by patents with extensive market coverage and, |
| | domestic | | thus, valuable. |
| | family patents | | |
| 23 | Forward- | + | This indicator is the total number of forward- |
| | citations by | | citations made by domestic patents with large |
| | examiners | | foreign patent families, added by examiners |
| | based on | | during the technical examination. This represents |
| | three or more | | that a patent is cited by patents with broad market |
| | foreign family | | coverage and, thus, is valuable. |
| | patents | | |
| *24 | Forward- | + | This indicator is the total number of forward- |
| | citations by | | citations made by influential assignees in the |
| | examiners | | same technological sector, added by examiners |
| | based on the | | during the technical examination. This represents |
| | top 10% | | the high value of the cited patent. |
| | assignees in | | |
| | the technical | | |
| | sector | | |
| | concerned | | |
| *25 | Forward- | + | This indicator is the total number of forward |
| | citations by | | citations made by influential assignees in the |
| | examiners | | same technological sector, added by examiners |
| | based on the | | during the technical examination this year. This |
| | top 10% | | represents the high value of the cited patent. |
| | assignees in | | |
| | the technical | | |
| | sector | | |
| | concerned | | |
| | this year | | |
| *26 | Forward- | + | This indicator is the total number of forward- |
| | citations by | | citations made by influential assignees in the |
| | examiners | | same technological sector, added by examiners |
| | based on the | | during the technical examination one to two years |
| | top 10 | | ago. This represents the high value of the cited |
| | assignees in | | patent. |
| | the technical | | |
| | sector | | |
| | concerned | | |
| | one to two | | |
| | years ago | | |
| *27 | Forward- | + | This indicator is the total number of forward- |
| | citations by | | citations made by patent giants, added by |
| | examiners | | examiners during the technical examination. This |
| | based on the | | represents the high value of the cited patent. |
| | patents | | |
| | currently | | |
| | owned by | | |
| | companies | | |
| | with more | | |
| | than 500 | | |
| | patent | | |
| | applications | | |
| | filed | | |
| *28 | Backward- | + | This indicator is the total number of patents added |
| | citations by | | to a patent as examiners' citations during the |
| | examiners | | technical examination. Backward citations missed |
| | | | by applicants and added by examiners work as a |
| | | | patent scope that blocks subsequent inventions. |
| 29 | Self- | + | This indicator is the total citations made to |
| | backward | | inventions belonging to the same agent and made |
| | citations by | | by examiners. It works as a patent scope. |
| | examiners | | |

Patent right

| | | | |
|---|---|---|---|
| 30 | Number of | + | This indicator is the total number of related |
| | continuing | | continuing patents. A continuing patent is a patent |
| | patents | | that follows and claims priority to an earlier-filed |
| | | | patent application. Any patent with a large number |
| | | | of related continuing patents tends to be related |
| | | | to the assignees' core business. |
| 31 | Number of | + | Claims of a patent determine the boundaries of |
| | claims | | the exclusive rights of the patent owner. |
| | | | Moreover, as the patent fee is proportional to the |
| | | | number of claims, a large number of claims imply |
| | | | higher fees and, therefore, reflect its expected |
| | | | market value. (Tong and Frame, 1994; Lanjouw |
| | | | and Schankerman, 2001, 2004) |
| 32 | Number of | + | Claims added or removed during technical |
| | added net | | examination mean a change in the exclusive right, |
| | claims | | and therefore are proportional to the patent value. |
| 33 | Number of | − | Multiple assignees make the usability of a patent |
| | multiple | | more complicated, and the coverage of the claims |
| | applicants | | is smaller due to conflicts of use among involved |
| | | | assignees., which is inversely proportional to the |
| | | | patent value. |
| 34 | Number of | +/− | The impact of inventor size on the patent value is |
| | inventors | | not linear. The single inventor has the highest |
| | | | frequency of all inventions, but it accounts only for |
| | | | a small fraction of high-value patents. The bigger |
| | | | size of inventors, however, has negative impacts |
| | | | on the patent quality. (Kiehne and Krill, 2017) |
| 35 | Number of | + | This indicator is the number of the distinct primary |
| | patent | | and secondary 4-digit subclasses of the |
| | classifications | | CPC(Cooperative Patent Classification) to which |
| | | | the invention is allocated. A patent's technical |
| | | | breadth has a positive impact on a firm's value. |
| | | | (Lerner, 1994; Hirshleifer et al., 2017) Matutes et |
| | | | al. (1996) suggest that a patent's breadth should |
| | | | be used to foster the early disclosure of |
| | | | fundamental innovation. |
| 36 | Patent | + | This indicator represents the remaining time for |
| | maturity | | the protection right of a patent. Longer maturity |
| | (months) | | makes a patent more valuable. |

The step of calculating patent score S1200 is a step in which weights for computing each patent score are calculated by performing the second principal component analysis on numerical values of the main quality indicators for analysis target patents whose right have not expired in a specific period among the valid patents, and the patent score of each analysis target patent is calculated based on the corresponding weights and numerical values of the main quality indicators. A patent score PSₚₜ calculated by giving a weight wᵢₜ for computing the patent score to the main quality indicators for the analysis target patents may be expressed by Equation 1 below.

PSₚₜ=Σᵢ₌₁¹⁹wᵢₜ·xₚᵢₜ [Equation 1]

In Equation 1, p means a specific analysis target patent, i means the i-th main quality indicator of the patent p, and t means a specific year. xₚᵢₜ is a natural logarithm of the i-th main quality indicator for patent p.

The step of calculating patent quality index for each company S1300 is a step in which the market size of the technology sector to which the analysis target patent belongs is calculated and using the market size as a weight, the patent index for each company is calculated by weighted-summing the patent scores of the analysis target patents for each company.

The step of calculating price-to-patent quality index ratio for each company S1400 is a step in which the price-to-patent index ratio (PPR) for each company is calculated by using the market capitalization and patent index for each company. The price-to-patent index ratio for each company is a ratio of the stock price per unit of patent quality, and if the corresponding ratio value is higher than that of another company, it may mean that the stock price is overvalued. Therefore, the price-to-patent index ratio for each company may be used as the company investment information. The market capitalization for each company may be extracted from pre-stored company information including the market capitalization of the company by year.

The step of providing company investment information S1500 is a step in which the specific period and specific company information is received from the terminal, the company investment information including at least one of valid patent information corresponding to the specific period and specific company information, the pre-stored company information, the numerical values of the main quality indicators, the patent index for each company, and the price-to-patent index ratio for each company is generated, and the corresponding information is provided to the terminal. The patent index may be of great help in determining the value of a portfolio of all patents held by a particular company.

Referring to FIG. 4, the step of selecting main patent quality indicators S1100 includes a step of calculating principal component coefficients by the first principal component analysis S1110 and a step of selecting main patent quality indicators S1120.

The step of calculating principal component coefficients by the first principal component analysis S1110 is a step in which the first principal component analysis is performed on the patent quality indicators to calculate principal component coefficients of principal components generated by a linear combination of the patent quality indicators. Therefore, in the step of calculating principal component coefficients by the first principal component analysis S1110, a statistical technique called principal component analysis is used to extract an appropriate number of indicators sufficiently explaining the change in patent quality. The principal component analysis is an analysis method commonly used for dimensionality reduction and data reduction so that, in a case where there is a strong correlation between variables, the fluctuations of the variables are concentrated on the first few principal components, and subsequent principal components are dominated by noise and may be ignored. In this process, the principal component is newly created by a linear combination of the original variables and satisfies an orthogonal relationship with no correlation. When the first principal component analysis is performed on the patent quality indicators in the step of calculating principal component coefficients by the first principal component analysis S1110, a principal component for representing the fluctuations of all patent quality indicators is calculated, and the corresponding principal component is expressed as a linear combination of all patent quality indicators. The coefficients of the principal component on the patent quality indicators may be calculated by Equation 2 below.

$$P {C}_{m} = {\sum }_{i = 1}^{k} {A}_{i m} \cdot {x}_{i} \qquad [ Equation 2 ]$$

In Equation 2, m means the m-th principal component (m=1, . . . , and k), and i means the i-th patent quality indicator. Aᵢₘ means the principal component coefficient of the i-th patent quality indicator on the m-th principal component, and xᵢ is a natural logarithm of the i-th indicator.

The step of selecting main patent quality indicators S1120 is a step in which the patent quality indicator, which is linearly combined with the principal component coefficient equal to or greater than a preset value among the principal component coefficients Aᵢₘ calculated in the step of calculating principal component coefficients by the first principal component analysis S1110, is selected as the main patent quality indicator. For example, in a case where the first principal component analysis is performed on 36 patent quality indicators for valid patents applied and registered from the end of 1980 to the end of 2017, the principal component coefficients for the patent quality indicators may express as shown in Table 2 below. In the step of selecting main patent quality indicators S1120, since the principal component coefficient in Table 2 generally has ranges from −0.14 to 0.36, 19 main quality indicators may be selected by setting the preset value to 0.27 or more. The range of the preset value may be the top 19 coefficients having the highest principal component coefficient.

TABLE 2

| Group | No. | Patent quality indicator | PC₁ | PC₂ | PC₃ | PC₄ | PC₅ |
|---|---|---|---|---|---|---|---|
| Technological | 1 | Forward-citation | 0.30 | −0.13 | −0.04 | −0.04 | 0.09 |
| significance | 2 | Adjusted forward-citation | 0.29 | −0.11 | 0.02 | −0.01 | 0.08 |
| | 3 | Forward-citations by foreign | 0.10 | −0.07 | 0.01 | −0.09 | 0.15 |
| | | assignees | | | | | |
| | 4 | Self-forward citations | 0.22 | 0.02 | 0.11 | 0.11 | −0.20 |
| | 5 | Average forward-citation | 0.20 | −0.12 | −0.11 | −0.06 | 0.10 |
| | | interval (months) | | | | | |
| Inventor | 6 | Number of applications | 0.10 | 0.36 | −0.12 | −0.04 | 0.00 |
| expertise | | (inventor average) | | | | | |
| | 7 | Number of registrations | 0.09 | 0.36 | −0.14 | −0.06 | 0.03 |
| | | (inventor average) | | | | | |
| | 8 | Registration ratio (inventor | −0.06 | −0.07 | −0.07 | −0.07 | 0.11 |
| | | average) | | | | | |
| | 9 | Number of adjusted forward- | 0.09 | 0.34 | −0.10 | −0.04 | 0.03 |
| | | citations (inventor average) | | | | | |
| | 10 | Number of patents with family | 0.09 | 0.36 | 0.00 | −0.05 | 0.07 |
| | | (inventor average) | | | | | |
| | 11 | Number of patents with | 0.04 | 0.20 | −0.03 | −0.03 | 0.06 |
| | | continuing patents (inventor | | | | | |
| | | average) | | | | | |
| | 12 | Average pending period | 0.02 | 0.06 | 0.05 | 0.10 | 0.02 |
| | | (inventor average, months) | | | | | |
| | 13 | Total number of claims (inventor | 0.11 | 0.32 | −0.10 | −0.04 | 0.04 |
| | | average) | | | | | |
| | 14 | Total remaining period of | 0.10 | 0.36 | −0.13 | −0.06 | 0.02 |
| | | patents (inventor average, | | | | | |
| | | month) | | | | | |
| Marketability | 15 | Patent family size (Applications) | 0.04 | 0.09 | 0.34 | 0.01 | 0.14 |
| | 16 | Patent family size (Distinct | 0.03 | 0.08 | 0.33 | 0.00 | 0.13 |
| | | authorities) | | | | | |
| | 17 | Intended worldwide protection | −0.01 | 0.03 | 0.27 | 0.01 | 0.09 |
| Novelty | 18 | Backward-citations | 0.02 | 0.03 | 0.28 | 0.18 | |
| | 19 | Self-backward citations | 0.07 | 0.14 | 0.21 | 0.20 | −0.10 |
| Patent scope | 20 | Forward-citations by examiners | 0.30 | −0.13 | −0.04 | −0.04 | 0.08 |
| | 21 | Self-forward citations by | 0.21 | 0.02 | 0.11 | 0.11 | −0.21 |
| | | examiners | | | | | |
| | 22 | Forward-citations by examiners | 0.27 | −0.08 | 0.04 | −0.03 | 0.07 |
| | | based on five or more domestic | | | | | |
| | | family patents | | | | | |
| | 23 | Forward-citations by examiners | 0.19 | −0.10 | −0.01 | −0.09 | 0.17 |
| | | based on three or more foreign | | | | | |
| | | family patents | | | | | |
| | 24 | Forward-citations by examiners | 0.30 | −0.05 | 0.01 | 0.02 | −0.11 |
| | | based on the top 10% | | | | | |
| | | assignees in the technical | | | | | |
| | | sector concerned | | | | | |
| | 25 | Forward-citations by examiners | 0.30 | −0.05 | 0.01 | 0.02 | −0.11 |
| | | based on the top 10% | | | | | |
| | | assignees in the technical | | | | | |
| | | sector concerned this year | | | | | |
| | 26 | Forward-citations by examiners | 0.30 | −0.05 | 0.01 | 0.02 | −0.11 |
| | | based on the top 10 assignees | | | | | |
| | | in the technical sector | | | | | |
| | | concerned one to two years ago | | | | | |
| | 27 | Forward-citations by examiners | 0.31 | −0.07 | −0.01 | 0.01 | −0.05 |
| | | based on the patents currently | | | | | |
| | | owned by companies with more | | | | | |
| | | than 500 patent applications | | | | | |
| | | filed | | | | | |
| | 28 | Backward-citations by | 0.02 | −0.02 | 0.20 | 0.15 | 0.31 |
| | | examiners | | | | | |
| | 29 | Self-backward citations by | 0.07 | 0.12 | 0.19 | 0.18 | −0.08 |
| | | examiners | | | | | |
| Patent right | 30 | Number of continuing patents | 0.01 | 0.06 | 0.07 | 0.01 | 0.09 |
| | 31 | Number of claims | 0.05 | 0.03 | 0.08 | 0.06 | 0.05 |
| | 32 | Number of added net claims | 0.00 | 0.00 | 0.00 | 0.00 | 0.00 |
| | 33 | Number of multiple applicants | −0.02 | 0.01 | 0.03 | 0.04 | 0.02 |
| | 34 | Number of inventors | 0.04 | 0.08 | 0.11 | 0.04 | −0.03 |
| | 35 | Number of patent classifications | 0.02 | 0.01 | 0.11 | −0.01 | 0.13 |
| | 36 | Patent maturity (months) | −0.09 | 0.09 | 0.18 | 0.10 | −0.09 |

| | | | | | |
|---|---|---|---|---|---|
| Variation proportion explained (%, accumulated) | 23% | 40% | 47% | 54% | 60% |

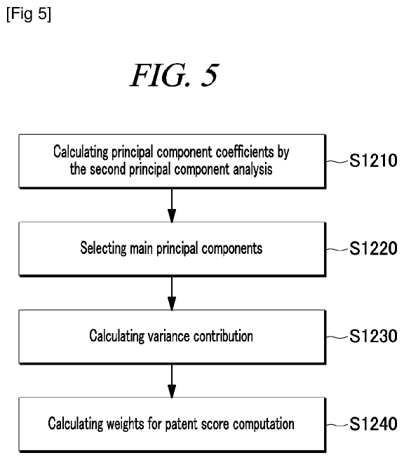

Referring to FIG. 5, the step of calculating patent score S1200 includes a step of calculating principal component coefficients by the second principal component analysis S1210, a step of selecting main principal components S1220, a step of calculating variance contribution S1230, and a step of calculating weights for patent score computation S1240.

The step of calculating principal component coefficients by the second principal component analysis S1210 is a step in which the principal component coefficients, the variance proportion, and the cumulative variance proportion of the principal components generated by a linear combination with the main quality indicators through the second principal component analysis on the main quality indicators for the analysis target patents are calculated. The step of selecting main principal components S1220 is a step in which principal components having a cumulative variance proportion of 90% or less are selected as the main principal components. The step of calculating variance contribution S1230 is a step in which the variance contributions of the main principal components are calculated based on the variance proportions and cumulative variance proportions of the main principal components. The step of calculating weights for patent score computation S1240 is a step in which the weights for computing the patent score is calculated based on the principal component coefficients and variance contribution of the main principal components. Here, the weight wᵢₜ for calculating the patent score may be expressed by Equation 3 below.

wᵢₜ=Σₘ₌₁^{k}Aᵢₘₜ·θₘₜ [Equation 3]

In Equation 3, m means the m-th main principal component (m=1, 2, 3, . . . , and k), i means the i-th main quality indicator for the analysis target patent, and t means a specific year. Aᵢₘₜ means the principal component coefficient of the i-th main quality indicator for the m-th main principal component, and θₘ means the variance contribution of the m-th main principal component.

As an example of the weight for calculating the patent score, if the second principal component analysis is performed on the main quality indicators for the analysis target patents at the end of 2000, the coefficient values for the main principal components linearly combined with the main quality indicators for the analysis target patents may be shown in Table 3 below. PC1 to PC4, which have a cumulative variance proportion of 90% or less shown in Table 3, are selected as the main principal components, and, for example, the influence coefficient of the “Number of applications (inventor average)”, the analysis target indicator No. 6, on determining the first main principal component PC1 is expressed as A_{number of applications (inventor average),1,2000}=0.125. Since the variance contribution θ_{1,2000} of the first main principal component PC1 is

$$\frac{variance proportion of first main principal component}{total variance proportion of main principal component} ,$$

it is calculated by

$$\frac{35 \%}{88 \%} = 0.4 .$$

Therefore, the weight of the analysis target indicator No. 6 is calculated as follows.

w_{number of applications (inventor average),2000}=Σₘ₌₁⁴A_{number of applications (inventor average),m,2000}·θ_{m,2000}=0.125*0.4+0.387*0.34+(−0.077)*0.14+(−0.001)*0.12=0.170

TABLE 3

| | | | | | | | | Weight |
|---|---|---|---|---|---|---|---|---|
| Group | No. | Patent quality indicator | PC₁ | PC₂ | PC₃ | PC₄ | PC₅ | (Wᵢₜ) |
| Technological | 1 | Forward-citation | 0.333 | −0.151 | −0.021 | 0.025 | 0.340 | 0.083 |
| significance | 2 | Adjusted forward-citation | 0.313 | −0.130 | 0.011 | 0.065 | 0.420 | 0.092 |
| Inventor | 6 | Number of applications | 0.125 | 0.387 | −0.077 | −0.001 | 0.026 | 0.170 |
| expertise | | (inventor average) | | | | | | |
| | 7 | Number of registrations | 0.124 | 0.392 | −0.094 | 0.004 | 0.047 | 0.169 |
| | | (inventor average) | | | | | | |
| | 9 | Number of adjusted | 0.127 | 0.375 | −0.089 | 0.037 | 0.066 | 0.170 |
| | | forward-citations (inventor | | | | | | |
| | | average) | | | | | | |
| | 10 | Number of patents with | 0.119 | 0.383 | 0.102 | −0.058 | 0.003 | 0.184 |
| | | family (inventor average) | | | | | | |
| | 13 | Total number of claims | 0.123 | 0.376 | −0.057 | 0.047 | 0.038 | 0.174 |
| | | (inventor average) | | | | | | |
| | 14 | Total remaining period of | 0.130 | 0.387 | −0.096 | 0.002 | 0.034 | 0.170 |
| | | patents (inventor average, | | | | | | |
| | | month) | | | | | | |
| Marketability | 15 | Patent family size | 0.027 | 0.092 | 0.585 | −0.189 | −0.066 | 0.101 |
| | | (Applications) | | | | | | |
| | 16 | Patent family size (Distinct | 0.026 | 0.078 | 0.584 | −0.211 | −0.052 | 0.094 |
| | | authorities) | | | | | | |
| | 17 | Intended worldwide | −0.032 | 0.034 | 0.429 | −0.051 | 0.279 | 0.053 |
| | | protection | | | | | | |
| Novelty | 18 | Backward-citations | 0.004 | 0.023 | 0.201 | 0.672 | −0.064 | 0.118 |
| Patent scope | 20 | Forward-citations by | 0.333 | −0.151 | −0.022 | 0.024 | 0.338 | 0.083 |
| | | examiners | | | | | | |
| | 22 | Forward-citations by | 0.313 | −0.107 | 0.063 | −0.011 | 0.204 | 0.097 |
| | | examiners based on five or | | | | | | |
| | | more domestic family | | | | | | |
| | | patents | | | | | | |
| | 24 | Forward-citations by | 0.344 | −0.079 | 0.007 | −0.023 | −0.388 | 0.110 |
| | | examiners based on the | | | | | | |
| | | top 10% assignees in the | | | | | | |
| | | technical sector concerned | | | | | | |
| | 25 | Forward-citations by | 0.348 | −0.079 | 0.009 | −0.025 | −0.379 | 0.112 |
| | | examiners based on the | | | | | | |
| | | top 10% assignees in the | | | | | | |
| | | technical sector concerned | | | | | | |
| | | this year | | | | | | |
| | 26 | Forward-citations by | 0.349 | −0.080 | 0.009 | −0.024 | −0.378 | 0.112 |
| | | examiners based on the | | | | | | |
| | | top 10 assignees in the | | | | | | |
| | | technical sector concerned | | | | | | |
| | | one to two years ago | | | | | | |
| | 27 | Forward-citations by | 0.355 | −0.095 | 0.010 | −0.027 | −0.107 | 0.110 |
| | | examiners based on the | | | | | | |
| | | patents currently owned by | | | | | | |
| | | companies with more than | | | | | | |
| | | 500 patent applications | | | | | | |
| | | filed | | | | | | |
| | 28 | Backward-citations by | 0.004 | 0.023 | 0.201 | 0.672 | −0.064 | 0.118 |
| | | examiners | | | | | | |

| | | | | | |
|---|---|---|---|---|---|
| Variance proportion explained (%, accumulated) | 35% | 65% | 77% | 88% | 92% |
| Variance proportion explained (%) | 35% | 30% | 12% | 11% | |
| Variance contribution (%) | 40% | 34% | 14% | 12% | |

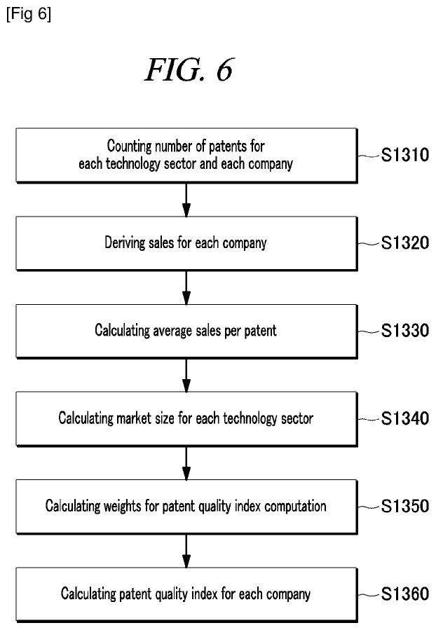

Referring to FIG. 6, the step of calculating patent quality index for each company S1300 includes a step of counting number of patents for each technology sector and each company S1310, a step of deriving sales for each company S1320, a step of calculating average sales per patent S1330, a step of calculating market size for each technology sector S1340, a step of calculating weights for patent quality index computation S1350, and a step of calculating the patent quality index for each company S1360.

The step of counting number of patents for each technology sector and each company S1310 is a step in which the number of patents for each technology sector and the number of patents for each company are counted on the analysis target patents. The technology sector may be any one of a Cooperative Patent Classification (CPC) code and an International Patent Classification (IPC) code of patents.

The step of deriving sales for each company S1320 is a step in which the sales for each company is derived. More specifically, the deriving step of the sales for each company S1320 is a step in which the sales for each company having the analysis target patents.

The step of calculating average sales per patent S1330 is a step in which the average sales per patent is derived based on the sales and number of patents for each company. More specifically, the step of calculating average sales per patent S1330 is a step in which the sales per patent for each company is calculated by dividing the sales for the company by the number of patents for the company, and the average sales per patent for each technology sector is calculated by dividing the sum of sales per patent of companies that have patents in the corresponding sector by the number of the companies. Here, it is assumed that each patent of a company makes the same contribution to the company's sales regardless of its technology sector, and unlisted companies that do not publicly report sales are excluded.

The step of calculating market size for each technology sector S1340 is a step in which the market size for each technology sector is calculated based on the average sales per patent and number of patents for each technology sector. More specifically, in the step of calculating market size for each technology sector S1340, the market size for each technology sector is calculated by multiplying the average sales per patent for each technology sector by the number of patents for each technology sector.

The step of calculating weights for the patent quality index S1350 is a step in which the weight for each technology sector is calculated as the ratio of the market size for the technology sector to the total market size of all technology sectors. The weight wₜ^{s} may be expressed by Equation 4 below.

$${w}_{t}^{s} = \frac{R E {V}_{t}^{s}}{{\sum }_{s = 1}^{{N SEC}_{t}} {REV}_{t}^{s}} \qquad [ Equation 4 ]$$

In Equation 4, t means a specific year, s means a specific technology sector, and REVₜ^{s} means the market size of the specific technology sector s in the specific year t.

As an example of the weight for the patent index computation, it is assumed that there are 3 patents in the year t whose CPC code, the technology sector of the analysis target patent, corresponds to A01D, and listed companies A and B, and unlisted company C each have one patent in the technology sector. In this case, if the sales of the company A are 10 billion Korean won and the number of owned patents is 100, the sales of the company A per patent is 100 million Korean won/pat. If the sales of the company B are 1 billion Korean won and the number of owned patents is 2, then the sales per patent of the company B is 500 million Korean won/pat. Here, it is assumed that the patents owned by the companies A and B make the same contribution to the sales regardless of the technology sector. The company C is excluded in calculating the sales per patent because the company is not listed and do not disclose its sales. Therefore, the average sales per patent becomes 300 million Korean won/pat, and the market size (900 million Korean won) of the technology sector A01D is derived by multiplying the average sales per patent (300 million Korean won/pat) by the number of patents belonging to the technology sector A01D (3 patents).

The step of calculating patent quality index for each company S1360 is a step in which the patent index is calculated based on the patent score and the above-mentioned weight. The patent index PIⱼₜ calculated by applying the above-mentioned weight wₜ^{s} to the patent score (PSₚₜ^{s}) may be expressed by Equation 5 below.

PIⱼₜ=Σ_{p∈j}wₜ^{s}·PSₚₜ^{s} [Equation 5]

In Equation 5, p means a specific analysis target patent owned by company j, t means a specific year, s means the technology sector of the corresponding patent, and j means the company holding these patents.

The method for providing investment information of a company through patent quality evaluation according to the embodiments of the present disclosure described above may be implemented in a form of a recording medium including instructions executable by a computer, such as a program module executed by a computer. The computer-readable media may be any available media that may be accessed by a computer and includes all of volatile and nonvolatile media, and removable and non-removable media. Also, computer-readable media may include computer storage media. The computer storage media includes all of volatile and nonvolatile media, and removable and non-removable media implemented in any method or technology for storage of information such as computer readable instructions, data structures, program modules or other data.

Those of ordinary skill in the art to which the present disclosure pertains will be able to understand that it may be easily modified into other specific forms without changing the technical spirit or essential features of the present disclosure based on the above-mentioned description. Therefore, it has to be understood that the embodiments described above are illustrative in all respects and not restrictive. The scope of the present disclosure is indicated by the following claims, and all changes or modifications derived from the meaning and scope of the claims and their equivalents has to be construed as being included in the scope of the present disclosure. The scope of the present application is indicated by the following claims rather than the above-mentioned detailed description, and all changes or modifications derived from the meaning and scope of the claims and their equivalents has to be construed as being included in the scope of the present application.

What is claimed is:

1. A method for providing investment information of a company through patent quality evaluation performed by a server, the method comprising:
(a) a step of calculating a numerical value of each of a plurality of patent quality indicators for each registered valid patents, and performing the first principal component analysis on the calculated numerical values to select a plurality of main quality indicators among from the patent quality indicators;
(b) a step of calculating numerical values of the main quality indicators for the analysis target patents whose right have not expired in a specific period among the valid patents, calculating weights of the main quality indicators for computing a patent score based on principal component coefficients obtained by conducting the second principal component analysis on the calculated numerical values, and calculating the patent scores of the analysis target patents based on the weights and numerical values of the main quality indicators;
(c) a step of calculating the weights for computing the patent quality index based on a market size of the technology sector to which the analysis target patent belongs, and calculating the patent quality index of the company corresponding to the right holder of the analysis target patents by weighted-summing patent scores with the weights; and
(d) a step of calculating a price-to-patent quality index ratio of the company by using the market capitalization and patent quality index of the company.

2. The method for providing investment information of a company through patent quality evaluation according to claim 1,
wherein the (a) step includes
(a-1) a step of performing the first main component analysis on the patent quality indicators to calculate principal component coefficients of principal components generated by a linear combination of the patent quality indicators; and
(a-2) a step of selecting, as the main quality indicator, the patent quality indicator having a principal component coefficient equal to or greater than a preset value from among the principal component coefficients calculated according to the (a-1) step.

3. The method for providing investment information of a company through patent quality evaluation according to claim 1,
wherein the (b) step includes
a step of calculating principal component coefficients, a variance proportion, and a cumulative variance proportion of each principal component generated by a linear combination with the main quality indicators through the second principal component analysis on the main quality indicators for the analysis target patents;
a step of selecting principal components of which the cumulative variance proportion is equal to or less than a preset value as the main principal components;
a step of calculating the variance contribution of each main principal component based on the variance proportions and cumulative variance proportions of the main principal components; and
a step of calculating weights for computing a patent score based on the principal component coefficients and variance contribution of the main principal components.

4. The method for providing investment information of a company through patent quality evaluation according to claim 1,
wherein the (c) step includes
a step of counting the number of patents for each technology sector and the number of patents for each company on the analysis target patents;
a step of deriving the sales for each company having the analysis target patents;
a step of calculating the average sales per patent for each technology sector based on the sales and number of patents for each company;
a step of calculating the market size for each technology sector based on the average sales per patent and number of patents for each technology sector;
a step of calculating a weight for computing the patent quality index, which is the ratio of the market size for a specific patent technology sector to the total market size for the entire technology sector based on the market size for each technology sector; and
a step of calculating the patent quality index for each company based on the patent scores and weights for computing the patent quality index.

5. The method for providing investment information of a company through patent quality evaluation according to claim 4, further comprising:
a step of receiving the specific period and specific company information from the terminal, and
a step of generating company investment information including at least one of the valid patent information corresponding to the specific period and the specific company information, the pre-stored company information, the numerical values of the main quality indicators, the patent quality index for each company, and the price-to-patent quality index ratio for each company, and providing the information to the terminal.

6. The method for providing investment information of a company through patent quality evaluation according to claim 1,
wherein the patent quality indicator includes
technological significance indicators including a forward-citation, an adjusted forward-citation, a forward-citation by foreign assignees, a self-forward citation, and an average forward-citation interval,
inventor expertise indicators including the average number of applications filed by inventors, the average number of patents registered by inventors, the average registration ratio by inventors, the average number of adjusted forward-citations by inventors, the average number of patent families by inventors, the average number of continuing patents by inventors, an average pending period by inventors, the average total number of claims by inventors, and an average of the total remained life of patents by inventors,
marketability indicators including the patent family size based on the applications, the patent family size based on the distinct authorities, and the intended worldwide protection,
novelty indicators including a backward-citation and a self-backward citation,
patent scope indicators including a citation added by examiners and a self-citation added by examiners, and
patent right indicators including the number of continuing patents, the number of claims, the number of added net claims, the number of multiple applicants, the size of inventors, the number of patent classifications, and a patent maturity.

7. A system for providing investment information of a company through patent quality evaluation with communication connection to a terminal, the system comprising:
a communication module that performs transmission and reception of information with the terminal;
a memory that stores a company investment information providing program; and
a processor that executes the program stored in the memory,
wherein the processor executes the company investment information providing program,
to calculate a numerical value of each of a plurality of patent quality indicators for valid patents, and perform the first principal component analysis on the numerical value to select a plurality of main quality indicators among from the patent quality indicators,
to calculate numerical values of the main quality indicators for the analysis target patents whose right have not expired in a specific period among the valid patents, calculate weights of the main quality indicators for computing a patent score based on principal component coefficients obtained by conducting the second principal component analysis on the calculated numerical values, and calculate the patent scores of the analysis target patents based on the weights and numerical values of the main quality indicators,
to calculate the weights for computing the patent quality index based on a market size of the technology sector to which the analysis target patent belongs, and calculate the patent quality index of the company corresponding to the right holder of the analysis target patents by weighted-summing patent scores with the weights, and
to calculate a price-to-patent quality index ratio of the company by using the market capitalization and patent quality index of the company.

8. The system for providing investment information of a company through patent quality evaluation according to claim 7,
wherein the processor performs the first principal component analysis on the patent quality indicators to calculate principal component coefficients of principal components generated by a linear combination of the patent quality indicators, and
selects, as the main quality indicator, the patent quality indicator having a principal component coefficient equal to or greater than a preset value from among the principal component coefficients.

9. The system for providing investment information of a company through patent quality evaluation according to claim 7,
wherein the processor calculates principal component coefficients, a variance proportion, and a cumulative variance proportion of each principal component generated by a linear combination with the main quality indicators through the second principal component analysis on the main quality indicators for the analysis target patents,
selects principal components of which the cumulative variance proportion is equal to or less than a preset value as main principal components;
calculates the variance contribution of each main principal components based on the variance proportions and cumulative variance proportions of the main principal components, and
calculates weights for computing a patent score based on the principal component coefficients and variance contribution of the main principal components.

10. The system for providing investment information of a company through patent quality evaluation according to claim 7,
wherein the processor counts the number of patents for each technology sector and the number of patents for each company on the analysis target patents,
derives the sales for each company having the analysis target patents,
calculates the average sales per patent for each technology sector based on the sales and number of patents for each company,
calculates the market size for each technology sector based on the average sales per patent and number of patents for each technology sector,
calculates a weight for calculating the patent quality index, which is the ratio of the market size for a specific technology sector to the total market size of the entire patent technology sector based on the market size for each technology sector, and
calculates the patent quality index for each company based on the patent scores and weights for computing the patent quality index.

11. The system for providing investment information of a company through patent quality evaluation according to claim 10,
wherein the processor receives the specific period and specific company information from the terminal, and
generates company investment information including at least one of the valid patent information corresponding to the specific period and the specific company information, the pre-stored company information, the numerical values of the main quality indicators, the patent quality index for each company, and the price-to-patent quality index ratio for each company, and provides the information to the terminal.

12. The system for providing investment information of a company through patent quality evaluation according to claim 7,
wherein the patent quality index includes
technological significance indicators including a forward-citation, an adjusted forward-citation, a forward-citation by foreign assignees, a self-forward citation, and an average forward-citation interval,
inventor expertise indicators including the average number of applications filed by inventors, the average number of patents registered by inventors, the average registration ratio by inventors, the average number of adjusted forward-citations by inventors, the average number of patent families by inventors, the average number of continuing patents by inventors, an average pending period by inventors, the average total number of claims by inventors, and an average total remained life of patents by inventors,
marketability indicators including the patent family size based on the applications, the patent family size based on the distinct authorities, and the intended worldwide protection,
novelty indicators including a backward-citation and a self-backward citation,
patent scope indicators including a citation added by examiners and a self-citation added by examiners, and
patent right indicators including the number of continuing patents, the number of claims, the number of added net claims, the number of multiple applicants, the size of inventors, the number of patent classifications, and a patent maturity.
